(19) United States
(12) Patent Application Publication
(10) Pub. No.: US 2009/0325119 A1
(43) Pub. Date: Dec. 31, 2009

(54) Orthodontic Appliance

(76) Inventor: Alexander J. Sierk, Davenport, IA (US)

Correspondence Address: HAMILTON IP LAW, PC, 331 W. 3RD ST., NEWVENTURES CENTER SUITE 120, DAVENPORT, IA, 52801, US

(21) Appl. No.: 12/491,159

(22) Filed: Jun. 24, 2009

Related U.S. Application Data
(60) Provisional application No. 61/075,806, filed on Jun. 26, 2008.

(51) Int. Cl. A61C 7/12

(52) U.S. Cl. 433/11

(57) ABSTRACT

An orthodontic appliance allowing the terminal ends of the archwire to be oriented and retained in a non-distal direction, as well as a method for using the disclosed appliance, is comprised of an appliance including at least a first and second archwire slot. The appliance is formed with a base and a body, wherein the body has two archwire slots passing therethrough. The archwire slots are arranged so that the archwire may be inserted into the first archwire slot in a distal direction and subsequently inserted into the second archwire slot in a non-distal direction (e.g., a substantially mesial, mesiolingual, mesiogingival, mesiogingivolingual distolingual, distogingival, or distogingivolingual direction). The archwire slots may be oriented as non-parallel to one another with respect to the vertical dimension and/or the transverse dimension. It is contemplated that at least the second archwire slot may be configured with a self-ligating archwire retaining mechanism.

### CROSS REFERENCE TO RELATED APPLICATIONS

This application claims the filing benefit under 35 U.S.C. §119(e) of provisional U.S. Patent Application Ser. No. 61/075,806 filed on Jun. 26, 2008, which is incorporated by reference herein in its entirety.

### FIELD OF THE INVENTION

The apparatus described herein is generally applicable to the field of orthodontics. The embodiments shown and described herein are more particularly for an improved archwire engaging and/or retaining apparatus and method of use therefor.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable.

### AUTHORIZATION PURSUANT TO 37 C.F.R. §1.71 (d)

A portion of the disclosure of this patent document contains material which is subject to copyright and trademark protection. The copyright owner has no objection to the facsimile reproduction by anyone of the patent document or the patent disclosure, as it appears in the Patent and Trademark Office patent file or records, but otherwise reserves all copyrights whatsoever.

### DETAILED DESCRIPTION—BRIEF DESCRIPTION OF DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

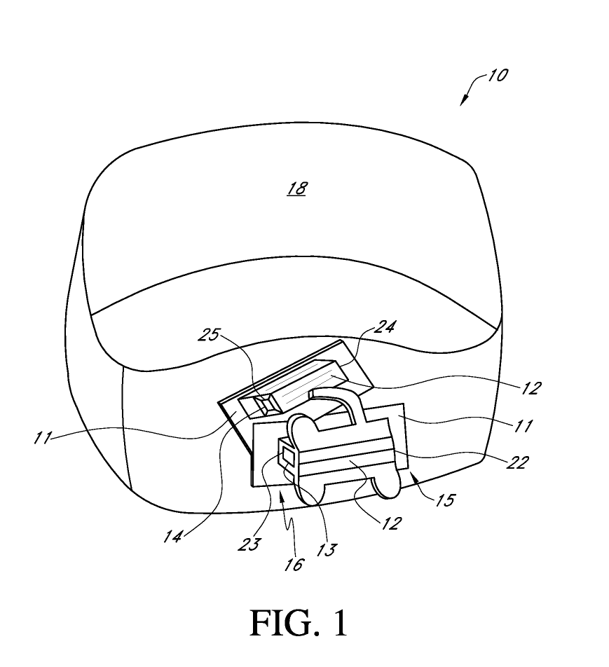

FIG. 1 provides a perspective view of a first embodiment of the appliance without an archwire inserted therein.

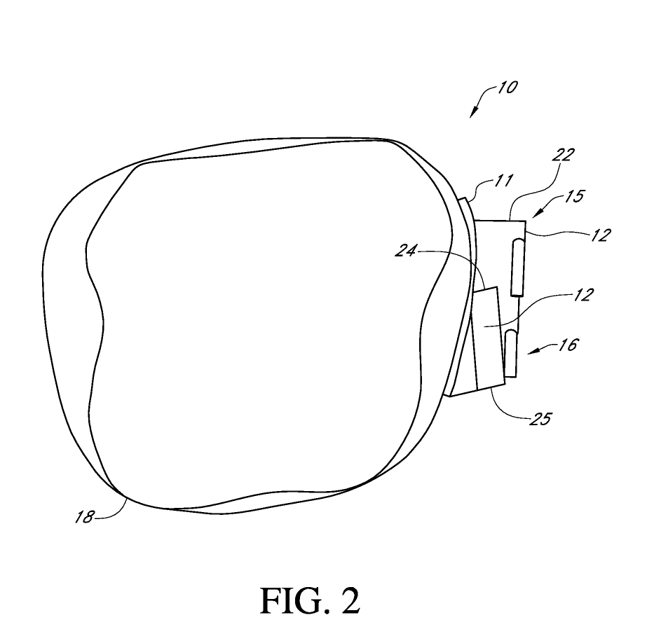

FIG. 2 provides a top view of the first embodiment of the appliance without an archwire inserted therein.

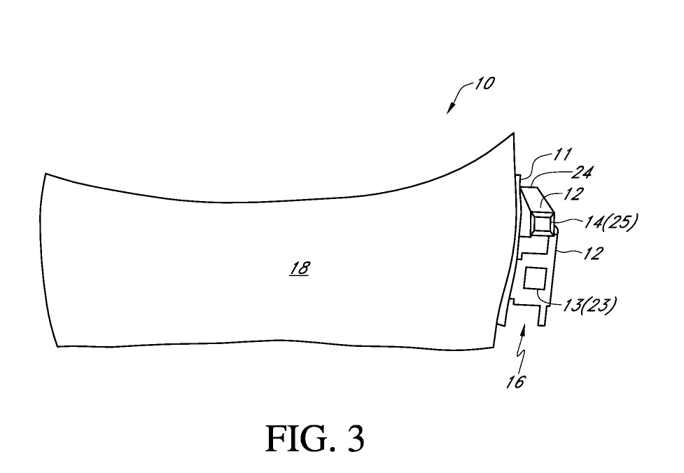

FIG. 3 provides a distal (rear) view of the first embodiment of the appliance without an archwire inserted therein.

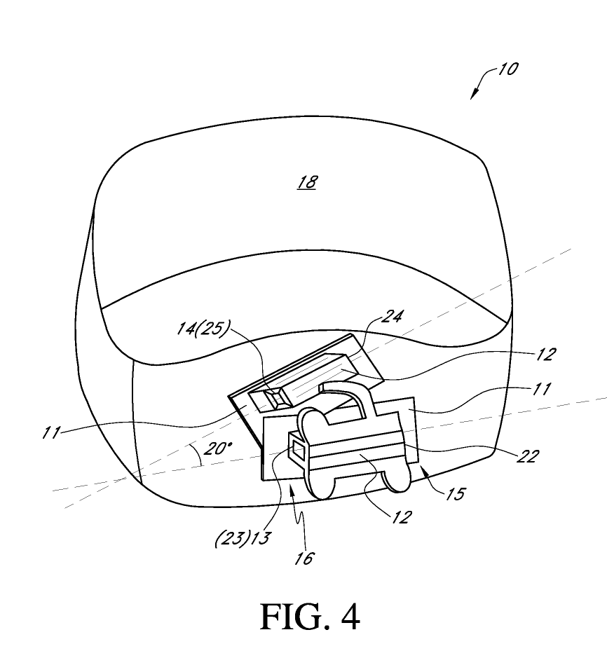

FIG. 4 provides a perspective view of the first embodiment of the appliance showing the respective angles of the archwire slots.

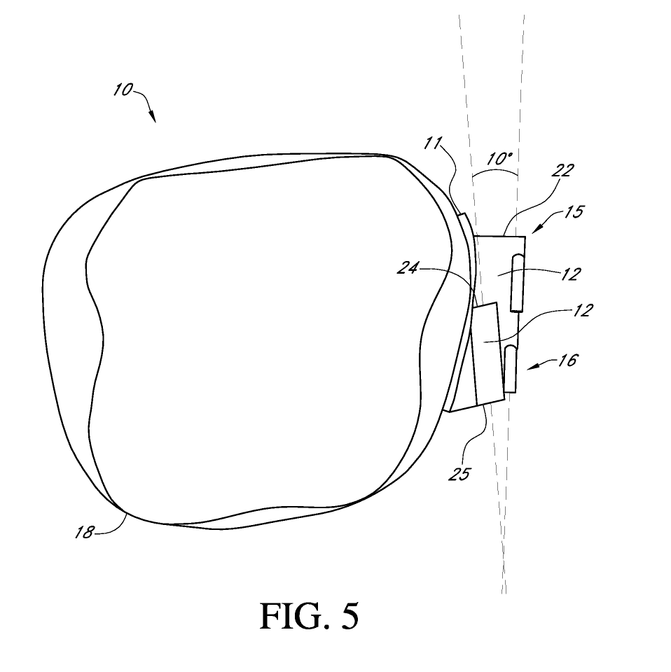

FIG. 5 provides a top view of the first embodiment of the appliance showing the respective angles of the archwire slots.

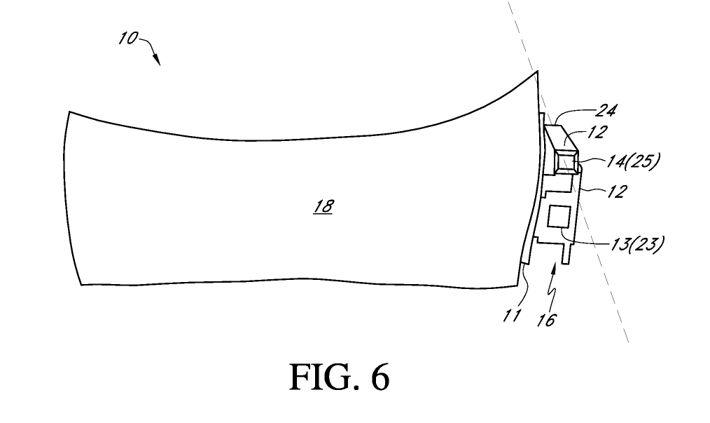

FIG. 6 provides a distal (rear) view of the first embodiment of the appliance showing the respective angles of the archwire slots.

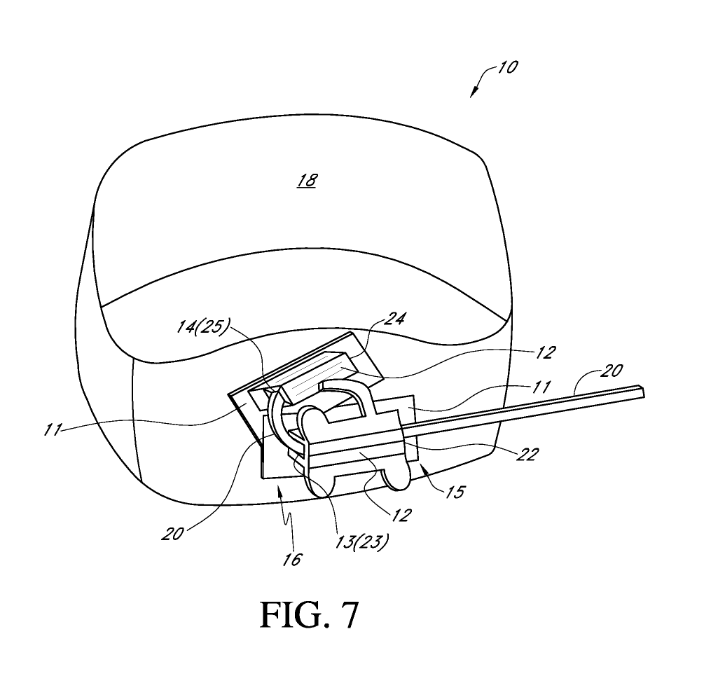

FIG. 7 provides a perspective view of the first embodiment of the appliance with an archwire inserted therein.

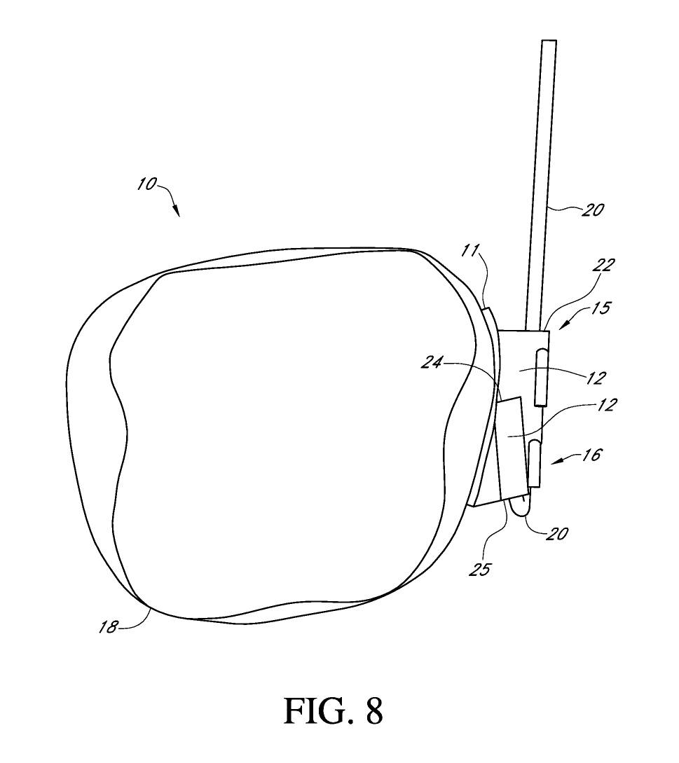

FIG. 8 provides a top view of the first embodiment of the appliance with an archwire inserted therein.

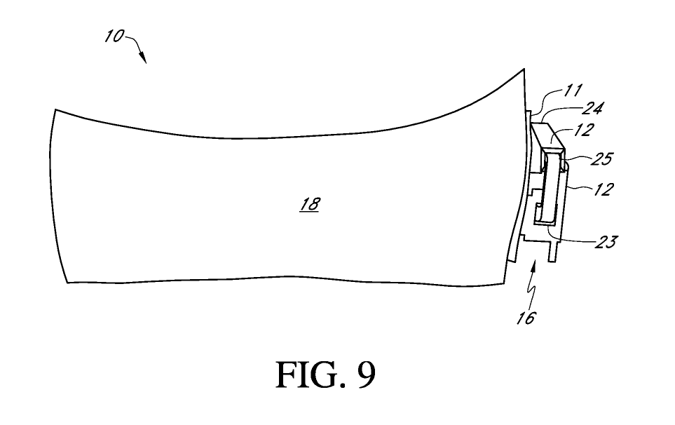

FIG. 9 provides a distal (rear) view of the first embodiment of the appliance with an archwire inserted therein.

### DETAILED DESCRIPTION—LISTING OF ELEMENTS

| Element Description | Element Number |
|---|---|
| Appliance | 10 |
| Base | 11 |
| Body | 12 |
| First Archwire Slot | 13 |
| Second Archwire Slot | 14 |
| Anterior Portion | 15 |
| Posterior Portion | 16 |
| Band | 18 |
| Archwire | 20 |
| First Archwire Slot Mesial Opening | 22 |
| First Archwire Slot Distal Opening | 23 |
| Second Archwire Slot Mesial Opening | 24 |
| Second Archwire Slot Distal Opening | 25 |

### DEFINITIONS

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

“Mesial” means in a direction toward the center of the patient's curved dental arch. “Distal” means in a direction away from the center of the patient's curved dental arch. “Occlusal” means in a direction toward the outer tips of the patient's teeth. “Gingival” means in a direction toward the patient's gums or gingiva. “Facial” means in a direction toward the patient's lips or cheeks. “Lingual” means in a direction toward the patient's tongue. “Anterior” means in a direction towards the front of the patient's body. “Posterior” means in a direction towards the back of the patient's body. “Vertical” and “Transverse” are used in the ordinary anatomical sense to denote planes in the vertical and horizontal dimensions, respectively, with respect to the anatomical position. “Non-distal” means in a direction that is not purely distal and is meant to include at least the directions of mesial, mesiogingival, mesiogingivolingual, distolingual, distogingival, and distogingivolingual.

### DETAILED DESCRIPTION OF INVENTION

Referring now to the drawings, wherein like reference numerals designate identical or corresponding parts throughout the several views, FIG. 1 provides a perspective view of the appliance 10 without an archwire 20 engaged therewith. The embodiments as depicted in the figures herein are primarily an appliance 10 designed to be a molar appliance for engagement with an upper right molar. Alternative embodiments of the appliance 10 include an arrangement for attachment to a lingual tooth surface, an arrangement for attachment to a facial tooth surface 17, or any other arrangement that is adapted to receive an archwire 20 for controlling movement of the associated tooth during the course of orthodontic therapy.

For many molar appliance applications, the appliance 10 will be used with a band 18, as explained in detail below. The appliance 10 includes a base 11, which is affixed to a band 18 in those embodiments employing a band 18. Alternatively, if no band 18 is used with the appliance 10 (e.g., when the appliance 10 is used as an orthodontic bracket), the base 11 may be directly bonded to the surface of the patient's tooth using an adhesive. In embodiments not employing a band 18, the base 12 preferably has an outwardly facing concave compound contour that matches the convex compound contour of the patient's tooth surface to which it is bonded. Optionally, the base 12 is formed with grooves, projections, particles, recesses, undercuts, a chemical bond enhancement material, or any combination thereof that facilitates bonding of the appliance 10 directly to the surface of the patient's tooth.

Affixed to the base 11 is the body 12, which extends from the base 11 in the facial direction. The body 12 includes a mesial portion 15 and a distal portion 16. In the embodiments pictured herein, the mesial portion 15 and distal portion 16 are formed as one continuous structure, but may be formed as separate projections from the base 11. Preferably the body 12 is integrally connected to the base 11, and the body 12 and the base 11 form a single, unitary component. Such a unitary component may be made, for example, in a machining or molding process such as metal injection molding. Other constructions are also possible, such as separately manufacturing the body 12 and base 11 and then later joining them through welding, brazing, or any other method appropriate for the materials of construction used.

Formed in the body 12 are first and second archwire slots 13, 14, respectively. The archwire slots 13, 14 are adapted for insertion of an archwire 20 therein to secure the archwire 20 within the archwire slots 13, 14. The archwire slots 13, 14 may be standard tube-style slots, or they may be self-ligating slots. Primarily, it is envisioned that at least the second archwire slot 14 will be self-ligating to facilitate ease of use of the appliance 10. The first archwire slot 13 longitudinally extends in a generally anterior-posterior direction across the appliance 10. The first archwire slot 13 serves as a primary slot, and the first archwire slot mesial opening 22 may be shaped as a funnel to facilitate insertion of the archwire terminal end (not shown) therein. In the embodiments pictured herein, the length of the second archwire slot 14 is less than the length of the first archwire slot 13 in the anterior-posterior dimension. However, the relative lengths of the archwire slots 13, 14 may vary depending on the application for the appliance 10 without departing from the spirit and scope of the present invention. Accordingly, the second archwire slot 14 may be shorter or longer than, or the same length as the first archwire slot 13 in the anterior-posterior dimension.

Whereas the first archwire slot 13 serves as a primary slot for engaging the archwire 20, the second archwire slot 14 serves as a retention slot and primarily functions to secure the archwire terminal end (not shown). The diameter of the second archwire slot 14 may be smaller in size than that of the first archwire slot 13. For example, if the diameter of the first archwire slot 13 is 0.022 inches, the diameter of the second archwire slot 14 may be 0.018 inches. Alternatively, the diameter of the second archwire slot 14 may be the same size or larger than the diameter of the first archwire slot 13.

In the first embodiment, the archwire slots 13, 14 are angled with respect to each other in the vertical dimension by 20 degrees, which is best shown in FIGS. 1, 4, and 7. In other words, the longitudinal axis of the second archwire slot 14 is angled from that of the first archwire slot 13 with respect to a horizontally oriented anterior-posterior plane by 20 degrees, but the angle may vary for different applications. Accordingly, the angle may be as little as 0 degrees, in which case the archwire slots 13, 14 would be parallel in the vertical dimension (which arrangement is explained in detail below for the third and fourth embodiments). As shown in FIGS. 1, 4, and 7, the distance between the first and second archwire slots 13, 14 at the anterior portion 15 of the body 12 is greater than the distance between the first and second archwire slots 13, 14 at the posterior portion 16 of the body 12 in an occlusal-gingival direction. Accordingly, the longitudinal axes of the archwire slots 13, 14 are not parallel when viewed from the vantage as depicted in FIGS. 1, 4, and 7.

To facilitate insertion of the archwire terminal end (not shown) into the second archwire slot 14, the second archwire slot distal opening 24 may be funneled. In an alternative embodiment not pictured herein, the second archwire slot 14 could be formed without the second archwire slot mesial opening 24, wherein the archwire 20 would need to be cut to the desired length prior to insertion into the second archwire slot 14. Such a configuration is commonly referred to as a “blind end” in medical applications.

In addition to the angle between the archwire slots 13, 14 in the vertical dimension, in the first embodiment, the first and second archwire slots 13, 14 are angled with respect to one another in the transverse dimension (i.e., a dimension that is horizontally oriented). As shown in FIGS. 2, 3, 5, 6, 8 and 9, the second archwire slot 14 is angled in a lingual direction with respect to the first archwire slot 13. FIGS. 3, 6, and 9 provide a view along the longitudinal axis of the first archwire slot 13 so that only the cross section of the archwire 20 is visible adjacent the first archwire slot distal opening 23. The white-colored void space in FIG. 6 represents a line passing through the center of the first archwire slot 13, which appears as a dot from the vantage of FIG. 6. From the vantage depicted in FIGS. 2 and 5 it is apparent that the distance between the first and second archwire slots 13, 14 at the anterior portion 15 is greater than the distance between the first and second archwire slots 13, 14 at the posterior 16 in a facial-lingual direction. Accordingly, the second archwire slot mesial opening 24 will be closer to the patient's tooth surface than is the second archwire slot distal opening 25. In the first embodiment, the angle between the archwire slots 13, 14 in the transverse dimension is 10 degrees. That is, the angle between the archwire slots 13, 14 in the vertical dimension is 20 degrees and the angle between the archwire slots 13, 14 in the transverse (horizontal) dimension is 10 degrees in the first embodiment. Both angles may vary for different applications, as explained in more detail relating to the second, third, and fourth embodiments described below.

In a second embodiment not pictured herein, the archwire slots 13, 14 are angled in the vertical dimension, but not in the transverse dimension. Accordingly, in the second embodiment the archwire slots 13, 14 are coplanar with respect to an occlusal-gingival plane, but as with the first embodiment, in the second embodiment the archwire slots 13, 14 are not parallel with respect to the anterior-posterior direction. That is, the transverse angle between the archwire slots 13, 14 is 0 degrees, but the vertical angle between the archwire slots 13, 14 is not 0 degrees.

In a third embodiment also not pictured herein, the archwire slots 13, 14 are not angled in the vertical dimension or the transverse dimension. Accordingly, the archwire slots 13, 14 in the third embodiment are coplanar with respect to an occlusal-gingival plane and parallel in the anterior-posterior direction. That is, the transverse angle between the archwire slots 13, 14 is 0 degrees, and the vertical angle between the archwire slots 13, 14 is also 0 degrees.

In a fourth embodiment not pictured herein, the archwire slots 13, 14 are not angled in the vertical dimension, but are angled in the transverse dimension. Accordingly, the archwire slots 13, 14 in the fourth embodiment are parallel in the anterior-posterior direction (i.e., the vertical angle is 0 degrees) but are non-coplanar with respect to an occlusal-gingival plane (i.e., the transverse angle is not 0 degrees).

In any of the embodiments disclosed herein, the appliance 10 allows for a method of positioning and securing the archwire terminal end (not shown) in a non-distal direction, which will dramatically reduce the number of patients experiencing irritation from the archwire terminal end (not shown) compared to an arrangement wherein the archwire terminal end (not shown) is positioned in a distal direction. Additionally, the appliance 10 will reduce the frequency of archwire 20 disengagement from the first archwire slot 13 (which serves as the primary slot) because of the orientation of the archwire slots 13, 14 with respect to one another and the archwire 20.

In operation, the user would secure the archwire 20 within at least one archwire-engaging bracket (not shown) on a tooth or teeth mesial to the appliance 10 (which serves as the molar band in the first embodiment as pictured herein). That is, the archwire 20 is first secured to archwire-engaging brackets (not shown) affixed to teeth that do not have the appliance 10 affixed thereto. Typically, a first appliance 10 would be positioned on the patient's tooth adjacent the location of a first archwire terminal end (not shown), which is on a first side of the patient's oral cavity. A second appliance 10 would then be positioned on another of the patient's teeth adjacent the location of a second archwire terminal end (not shown), which is typically on a second side of the patient's oral cavity. Often times the first and second archwire terminal ends (not shown) are generally symmetrical with respect to the patient's curved dental arch, but the appliance 10 is not limited to such uses.

The user then inserts the first archwire terminal end (not shown) through the first archwire slot 13 in the first appliance 10 in a distal direction. That is, the first archwire terminal end (not shown) would be inserted into the first archwire slot mesial opening 22 and protrude from the first archwire slot distal opening 23. The user would then bend the archwire 20 at a location near the first archwire terminal end (not shown) and insert the first archwire terminal end (not shown) through the second archwire slot 13 in the first appliance in a predominantly mesial direction. That is, the first archwire terminal end (not shown) would be inserted into the second archwire slot distal opening 25 and come out the second archwire slot mesial opening 24. This procedure would then be carried out on the second appliance 10 located on the second side of the patient's oral cavity. Through this procedure, the archwire terminal ends (not shown) are pointing in a non-distal direction. The non-distal direction in which the archwire terminal ends (not shown) are oriented may be mesial, mesiogingival, mesiogingivolingual, distolingual, distogingival, and distogingivolingual, depending on the specific embodiment of the appliance 10 used. Accordingly, the archwire terminal ends (not shown) are less likely to cause irritation in the patient's oral cavity. Furthermore, this orientation reduces the likelihood that the archwire 20 will become disengaged from the first archwire slot 13 (i.e., the primary slot). As is well known to those skilled in the art, the archwire terminal end (not shown) may be heat treated so to retain a certain shape.

The optimal angle between the archwire slots 13, 14 with respect to the vertical dimension and the transverse dimension will vary depending on several factors, including but not limited to: (1) the material of construction for the archwire 20; (2) the material of construction for the appliance 10; (3) the patient's age, sex, and weight; (4) the shape and condition of the patient's oral cavity; and/or, (5) the correction the patient needs. It is contemplated the vertical angle between the archwire slots 13, 14 will be within the range of 0 to 90 degrees in most applications. It is further contemplated the transverse angle between the archwire slots 13, 14 will be within the range of 0 to 90 degrees in most applications. In other applications the two angles may be greater than 90 degrees, depending on the specific application. Accordingly, those skilled in the art may employ the appliance 10 using angles from 0 to 180 degrees without departing from the spirit and scope of the present invention. As described in detail above, in the first embodiment the vertical angle is 20 degrees and the transverse angle is 10 degrees.

The appliance 10 may be outfitted with self-ligating components, such as those disclosed in U.S. Pat. Nos. 7,377,777 and 7,267,545, both of which are incorporated by reference herein in their entireties. Self-ligating components would be especially useful in the second archwire slot 14 to ease archwire 20 placement. Alternatively, the appliance 10 may be used in conjunction with orthodontic brackets and components of other types, such as those disclosed in U.S. Pat. Nos. 6,733,285 and 5,913,680, both of which are incorporated by reference herein in their entireties.

The archwire slots 13, 14 may have any cross-sectional shape. For example, the cross-sectional shape of the archwire slots 13, 14 may be square, circular, oblong, triangular, etc. The desired cross-sectional shape of the archwire slots 13, 14 will often be dictated by the cross-sectional shape of the archwire 20 and may vary from one application to the next.

The appliance 10 and/or any elements thereof, including the body 11, base 12, and archwire slots 13, 14, maybe constructed of any material known to those skilled in the art, which material is appropriate for the application of the appliance 10. Such materials include, but are not limited to, a ceramic material (for example, aluminum oxide), a metallic material (for example, stainless steel), or a plastic material (for example, a fiber-reinforced polycarbonate). Additionally, an archwire slot liner (not shown) may be provided.

In another embodiment of the appliance 10 not pictured herein, the base 11 is formed as two distinct portions. In this embodiment, each portion of the base 11 may have a separate band 18 associated therewith. Furthermore, each portion of the base 11 in this embodiment may have a distinct body 12 affixed thereto, wherein each body 12 may include at least one archwire slot 13, 14. In this embodiment, each portion of the base 11 and the body 12 associated therewith may be integrally formed with one another or separately formed and later affixed to one another, as is well known to those skilled in the art.

It should be noted that the present invention is not limited to the specific embodiments pictured and described herein, but is intended to apply to all similar apparatuses for allowing the archwire terminal ends (not shown) to be oriented substantially in a non-distal direction (e.g., a mesial, mesiogingival, mesiogingivolingual, distolingual, distogingival, or distogingivolingual). Accordingly, modifications and alterations from the described embodiments will occur to those skilled in the art without departure from the spirit and scope of the present invention.

Furthermore, variations and modifications of the foregoing are within the scope of the appliance 10. It is understood that the appliance 10 as disclosed and defined herein extends to all alternative combinations of two or more of the individual features mentioned or evident from the text and/or drawings. All of these different combinations constitute various alternative aspects of the appliance 10. The embodiments described herein explain the best modes known for practicing the appliance 10 and will enable others skilled in the art to utilize the same. The claims are to be construed to include alternative embodiments to the extent permitted by the prior art.

All of the patents and/or patent applications mentioned above are hereby expressly incorporated by reference herein in their entireties. The embodiments described in detail above and shown in the drawings are intended to exemplify the invention, and should not be deemed to limit the scope of the claims that follow

What is claimed is:

1. An orthodontic appliance comprising:
a. a base;
b. a body extending outwardly from said base;
c. a first archwire slot formed in said body, wherein said first archwire slot extends across a portion of said appliance in a generally anterior-posterior direction; and
a. a second archwire slot formed in said body, wherein said second archwire slot extends across a portion of said appliance, and wherein said second archwire slot is not parallel with said first archwire slot with respect to the vertical dimension.

2. The orthodontic appliance according to claim 1 wherein said second archwire slot is further defined as being angled with respect to said first archwire slot in the transverse dimension.

3. The orthodontic appliance according to claim 1 wherein said second archwire slot is further defined as being placed above said second archwire slot in the vertical dimension.

4. The orthodontic appliance according to claim 3 wherein said first archwire slot is further defined as being substantially parallel to a horizontal plane.

5. The orthodontic appliance according to claim 4 wherein said second archwire slot is further defined as being angled with respect to said first archwire slot in the vertical dimension by approximately twenty degrees.

6. The orthodontic appliance according to claim 5 wherein said second archwire slot is further defined as being angled with respect to said first archwire slot in the horizontal dimension by approximately twenty degrees.

7. The orthodontic appliance according to claim 1 wherein said second archwire slot is further defined as being angled with respect to said first archwire slot in the horizontal dimension by approximately twenty degrees.

8. The orthodontic appliance according to claim 1 wherein said second archwire slot is further defined as being a self-ligating slot.

9. An orthodontic appliance comprising:
a. a base;
b. a first body extending outwardly from said base;
c. a second body extending outwardly from said base;
d. a first archwire slot formed in said first body, wherein said first archwire slot extends across a portion of said appliance in a generally anterior-posterior direction; and
e. a second archwire slot formed in said second body, wherein said second archwire slot extends across a portion of said appliance, and wherein said second archwire slot is not parallel with said first archwire slot with respect to the vertical dimension.

10. The orthodontic appliance according to claim 9 wherein said second archwire slot is further defined as being placed above said second archwire slot in the vertical dimension.

11. The orthodontic appliance according to claim 10 wherein said first archwire slot is further defined as being substantially parallel to a horizontal plane.

12. The orthodontic appliance according to claim 10 wherein said second archwire slot is further defined as being angled with respect to said first archwire slot in the transverse dimension.

13. The orthodontic appliance according to claim 9 wherein said second archwire slot is further defined as being a self-ligating slot.

14. The orthodontic appliance according to claim 9 wherein said base is further defined as comprising a first and second portion, wherein said first body is affixed to said first portion, and wherein said second body is affixed to said second portion.

15. A method for securing an archwire in an orthodontic appliance comprising:
a. inserting said archwire into respective archwire engaging portions of a plurality of archwire-engaging brackets adhered to a patient's teeth;
b. inserting a first terminal end of said archwire in a distal direction into a first archwire slot formed in a first orthodontic appliance located on a first side of a patient's oral cavity;
c. bending said first terminal end of said archwire so that said first terminal end of said archwire is oriented in a non-distal direction;
d. inserting said first terminal end of said archwire in a non-distal direction into a second archwire slot formed in said first orthodontic appliance located on said first side of said patient's oral cavity;
e. inserting a second terminal end of said archwire in a distal direction into a first archwire slot formed in a second orthodontic appliance located on a second side of said patient's oral cavity;
f. bending said second terminal end of said archwire so that said second terminal end of said archwire is oriented in a non-distal direction; and,
g. inserting said second terminal end of said archwire in a non-distal direction into a second archwire slot formed in said second orthodontic appliance located on said second side of said patient's oral cavity.

16. The method according to claim 15 wherein said first orthodontic appliance located on said first side of said patient's oral cavity is further defined as the most distally oriented orthodontic appliance located on said first side of said patient's oral cavity.

17. The method according to claim 15 wherein said second orthodontic appliance located on said second side of said patient's oral cavity is further defined as the most distally oriented orthodontic appliance located on said second side of said patient's oral cavity.

18. The method according to claim 15 wherein said non-distal direction is further defined as being a direction selected from a group consisting of mesial, mesiogingival, mesiolingual, mesiogingivolingual, distolingual, distogingival, and distogingivolingual directions.

19. The method according to claim 15 wherein said second archwire slot in said first orthodontic appliance and said second archwire slot in said second orthodontic appliance are further defined as being self-ligating slots.
